(19) United States
(12) Patent Application Publication
(10) Pub. No.: US 2012/0057239 A1
(43) Pub. Date: Mar. 8, 2012

(54) LIGHT SCATTERING SHEET AND PROCESS FOR PRODUCING THE SAME

(75) Inventors: Kazuhiro Shiojiri, Kanagawa (JP); Kazuhiro Oki, Kanagawa (JP); Yusuke Ohashi, Kanagawa (JP)

(73) Assignee: FUJIFILM CORPORATION, Tokyo (JP)

(21) Appl. No.: 13/039,753

(22) Filed: Mar. 3, 2011

(30) Foreign Application Priority Data
Mar. 3, 2010 (JP) 2010-046892

(51) Int. Cl. G02B 5/02; B05D 3/02; B05D 3/06; B05D 5/06

(52) U.S. Cl. 359/599; 427/162; 427/508; 427/496

(57) ABSTRACT

A process for producing a light scattering sheet includes: a coating step of coating a transparent support with a coating solution prepared by dissolving a resin material including at least two kinds selected from polymers and monomers phase-separable with each other in a solvent to form a coating layer; and a drying step of drying the coating layer to form a phase separated concavity and convexity structure on the coating layer by spinodal decomposition, wherein, in the drying step, high speed drying is carried out at a drying speed of 3.0 g/m²·sec or more at a critical phase separation concentration of the coating layer applied to the transparent support.

### BACKGROUND OF THE INVENTION

1. Field of the Invention

The presently disclosed subject matter relates to a light scattering sheet and a process for producing the same, and in particular, to a light scattering sheet used for a liquid crystal display device, and a process for producing the same.

2. Description of the Related Art

Liquid crystal displays have been recently widely used since they are thin and lightweight. Generally, a cold cathode fluorescent lamp (CCFL) or LED (light-emitting diode) is used as a light emitting source for a backlight unit included in a light source of a liquid crystal display. Such light sources are linear or point light sources, and have brightness distribution. To convert them into area light sources, members which scatter light, such as light scattering (or light diffusion) sheet, have been used.

Further, prism sheets, reflective polarizing films or the like have been used to condense light to improve the brightness of light sources. It is known that when a film such as prism sheet, which has a regular structure, is provided, distribution of brightness occurs in a specific direction. To convert it into an area light source, a light scattering sheet is provided on the top of backlight so that light emitted by the backlight is scattered.

Alternatively, a prism sheet is used to control optical path, and to avoid generation of moire caused by the interference of the optical path control light with pixels of liquid crystal cells, a light scattering sheet is provided to scatter light which enters a polarizing plate.

As an example of such light scattering sheets, Japanese Utility Model Application Laid-Open No. 5-73602 has disclosed a light scattering sheet in which bead particles are embedded in a synthetic resin. Also, Japanese Patent Application Laid-Open No. 5-169015 discloses a light scattering sheet with concavity and convexity shapes formed on the surface by a roll intaglio on which a fine emboss pattern is formed. Further, Japanese Patent Application Laid-Open No. 2005-195819 discloses a method using phase dissociation (phase separation) and discloses an anti-glare film having a fine concavity-and-convexity structure on the surface, in which a region having an angle of inclination with respect to the surface of 2.5° to 7.5° accounts for 20% or less. International Publication WO2007/108294 discloses an anti-glare film in which image clarity varies depending on the direction where the film is positioned.

Each of these light scattering sheets is designed to be put on members which cause uneven brightness, such as prism sheet, and is intended to generate a uniform area light source.

Scattering properties of a light scattering layer containing particles need to be controlled by the particle size. However, it is difficult to control coagulation and dispersion of particles, and satisfactory scattering properties cannot be achieved. Further, in the case of embossing, since a regular pattern is formed, scattering angles peak at a specific angle, causing problems such as glare.

On the other hand, in the method using phase dissociation, scattering properties are insufficient when the angle of inclination is small, failing to remove uneven brightness or moire completely. Further, when image clarity varies depending on the direction where the sheet is positioned, anisotropy of viewing angles is generated.

Moreover, since conventional light scattering sheets are normally an independent member, the number of sheets stacked is unwillingly increased. Therefore, thinning of a light scattering sheet is required, but there are limitations to thinning in terms of the strength and the like of a light scattering sheet. Under such circumstances, Japanese Patent Application Laid-Open No. 2000-75134 discloses a light diffusing polarizing plate in which, of the protective sheets closely attached on both sides of a polarizing plate, the protective sheet on the light incident side has a light scattering function to attempt a reduction in the number of members and thinning of the members. According to Japanese Patent Application Laid-Open No. 2000-75134, an area light source can be obtained without using conventional light scattering sheets.

In this case, properties required for such protective sheets include low optical anisotropy such as retardation. Therefore, generally triacetyl cellulose (TAC) is used.

### SUMMARY OF THE INVENTION

However, the light diffusing polarizing plate of Japanese Patent Application Laid-Open No. 2000-75134 has a problem of reduced front brightness due to low total light transmittance. Moreover, when the total light transmittance is increased, light scattering properties are reduced, causing another problem of failing to effectively prevent uneven brightness or moire from occurring.

Further, as described above, when a protective sheet for a polarizing plate has a light scattering function, TAC is generally used as a material of the sheet, but TAC has a problem of getting wrinkled when dried at a high temperature of about 120° C. in the production of a light scattering sheet, causing deterioration of optical properties, and thus being unable to also serve as a protective sheet.

The presently disclosed subject matter has been made in view of such circumstances and an object thereof is to provide a light scattering sheet which has excellent light scattering properties, can effectively prevent uneven brightness or moire from occurring, can be produced without wrinkles even if triacetyl cellulose is used as a support and therefore can also serve as a protective sheet for a polarizing plate to reduce the number of members and accomplish thinning of liquid crystal display devices, and a process for producing the same.

To accomplish the aforementioned object, a process for producing a light scattering sheet according to a first aspect of the presently disclosed subject matter includes: a coating step of coating a transparent support with a coating solution prepared by dissolving a resin material including at least two kinds selected from polymers and monomers phase-separable with each other in a solvent to form a coating layer; and a drying step of drying the coating layer to form a phase separated concavity and convexity structure on the coating layer by spinodal decomposition, wherein, in the drying step, high speed drying is carried out at a drying speed of 3.0 g/m²·sec or more at a critical phase separation concentration of the coating layer applied to the transparent support.

The inventor of the presently disclosed subject matter has found that when drying a coating layer formed by coating a transparent support with a coating solution prepared by dissolving a resin material containing at least two kinds selected from polymers and monomers phase-separable with each other in a solvent, a light scattering sheet with a phase separated concavity-and-convexity structure, which has strong scattering properties and can remove uneven brightness or moiré, can be produced by carrying out high speed drying at a drying speed of 3.0 g/m²·sec or more at a critical phase separation solid concentration of the coating layer. The presently disclosed subject matter has established a specific process for producing a light scattering sheet based on the above findings. The drying speed at the critical phase separation solid concentration of the coating layer is more preferably 8 g/m²·sec or more, and particularly preferably 10 g/m²·sec or more. The upper limit of the drying speed at the critical phase separation concentration is where no drying unevenness occurs, and for example, is preferably 20 g/m²·sec or less.

Herein, the drying speed at the critical phase separation concentration refers to a drying speed for a coating layer at a solid concentration at which phase separation of two or more resin materials constituting the coating layer starts. The phase separated concavity-and-convexity structure refers to a concavity-and-convexity structure formed by phase separated materials.

In the presently disclosed subject matter, it is important that after the start of drying, the drying speed reaches 3.0 g/m²·sec or more no later than before the solid concentration at which phase separation begins (critical phase separation solid concentration) is reached. Once the critical phase separation solid concentration is reached, the advantageous effect of the presently disclosed subject matter cannot be obtained no matter how the drying speed is increased. Therefore, for example, even if windless or low air volume low speed drying is carried out after the start of drying for some time and then high speed drying is carried out at 3.0 g/m²·sec or more, the advantageous effect of the presently disclosed subject matter cannot be achieved if the solid concentration exceeds the critical phase separation solid concentration during the low speed drying. In other words, low speed drying of a coating solution generates rotary convection in the coating layer due to a difference in the temperature or density between the upper portion and the lower portion of the coating layer. This results in generation of convection cells and thus a regular and periodical phase-separated concavity and convexity structure with a plurality of cellular domains is formed.

In the presently disclosed subject matter, on the other hand, a coating layer applied to a transparent support is subjected to high speed drying at a drying speed of 3.0 g/m²·sec or more at a critical phase separation solid concentration of the coating layer in the drying step. Therefore the solid concentration in the coating layer rapidly increases, making it possible to dry the coating layer under drying conditions where rotary convection hardly occurs. In particular, the Marangoni number is preferably less than 80 at the critical phase separation concentration. Accordingly, in a light scattering sheet produced by the process of the presently disclosed subject matter, domains formed by phase separation has a random structure mainly of string-shaped domains, not regular or periodical vortical domains formed by rotary convection. At the same time, distances between domains are reduced. This offers excellent light scattering properties and makes it possible to remove uneven brightness or moire.

The Marangoni number (Ma) is expressed by a following formula:

Ma=(t/μκ)×|∂σ/∂T|×ΔT.

The denotations in the above formula represent following physical quantities:

t: thickness (m) of a coating layer;

μ: viscosity (N·s/m²) of a coating solution;

κ: heat conductivity (W/m·K);

|∂σ/∂T|: temperature differentiation (N/m·K) of surface tension σ (N/m); and

ΔT: temperature difference (K) between one surface of the coating layer and another surface thereof.

The critical point of Marangoni number (Ma) where Marangoni convection occurs is Ma=80. Marangoni convection does not occur when Marangoni number (Ma) is less than 80 (Ma<80).

Also, in the process of the presently disclosed subject matter, it is preferred that in the coating step, the solvent for the coating solution include a solvent having a boiling point of 100° C. or less, and in the high speed drying in the drying step, the temperature of drying air be kept at the boiling point of the solvent or higher and 130° C. or less and the drying speed described above be achieved by increasing the speed of the drying air.

By doing so, even if a coating layer is subjected to high speed drying using triacetyl cellulose as a transparent support, no wrinkle is generated on the transparent support by drying heat and thus optical properties of a polarizing plate protective film are not deteriorated. Therefore, the light scattering sheet of the presently disclosed subject matter can also serve as a protective sheet for a polarizing plate, making it possible to reduce the number of members to accomplish thinning of liquid crystal display devices.

Also, in the process of the presently disclosed subject matter, it is preferred that the coating solution contain an ionizing radiation-curable compound and the coating layer applied to the support be cured by a cross-linking reaction or a polymerization reaction by irradiating the coating layer with light or electron beams or by heating, thereby fixing the phase separated concavity-and-convexity structure formed.

This makes it possible to fix the above-described phase separated concavity-and-convexity structure formed in the drying step without change.

It is preferred that the monomers used in the presently disclosed subject matter include a multifunctional monomer. It is also preferred that a surfactant be included as one of the polymers or monomers.

To accomplish the aforementioned object, the light scattering sheet of the presently disclosed subject matter has, on a transparent support, a light scattering layer having a phase separated concavity-and-convexity structure formed by phase separation of two or more resin materials phase-separable with each other, and the phase separated concavity-and-convexity structure is a sea-island structure of the two or more resin materials, and a plurality of domains constituting an island have a random shape mainly of a string shape.

As a result, the light scattering sheet has excellent light scattering properties and also can effectively prevent uneven brightness or moire from occurring.

It is preferred that the light scattering sheet of the presently disclosed subject matter have a transmitted image clarity of 10% to 30% and a haze of 20% to 60%, and a percentage of a surface inclination angle of the phase separated concavity-and-convexity structure in the range of 2.5° to 7.5° of 21% to 50%.

It is preferred that in the light scattering sheet of the presently disclosed subject matter, triacetyl cellulose be used as the transparent support and the light scattering sheet also serve as a protective sheet for a polarizing plate on the backlight side of a liquid crystal display device.

As a result, the number of members can be reduced and thinning of liquid crystal display devices can be accomplished.

Further, it is preferred that the two or more resin materials have different refractive indices. Moreover, it is preferred that at least one be of the two or more resin materials a (meta-)acrylate resin.

The light scattering sheet and the process for producing the same of the presently disclosed subject matter can effectively prevent uneven brightness or moire from occurring with maintaining excellent light scattering properties.

Further, a light scattering sheet can be produced without wrinkles even if triacetyl cellulose is used as a transparent support to which a coating solution for a light scattering sheet is applied. As a result, the light scattering sheet can also serve as a protective sheet for a polarizing plate, and thus the number of members can be reduced and thinning of liquid crystal display devices can be accomplished.

### BRIEF DESCRIPTION OF THE DRAWINGS

FIG. 1 is a reflection laser micrograph of a phase separated concavity-and-convexity structure on a surface of a light scattering sheet of the presently disclosed subject matter;

FIG. 2 is an explanatory view illustrating a method of measuring a drying speed for a coating layer;

FIG. 3 is an explanatory view illustrating a critical concentration of a coating layer;

FIG. 4 is a side view illustrating a preferred coating-drying apparatus for the process for producing a light scattering sheet of the presently disclosed subject matter;

FIG. 5 is a top view of the coating-drying apparatus of FIG. 4;

FIG. 6 is a view illustrating a modified example of the coating-drying apparatus;

FIG. 7 is a top view of the coating-drying apparatus of FIG. 6;

FIG. 8 is a cross-sectional view of the coating-drying apparatus of FIG. 6; and

FIG. 9 is a table illustrating Examples of the presently disclosed subject matter.

### DETAILED DESCRIPTION OF THE PREFERRED EMBODIMENTS

In the following, preferred embodiments of the light scattering sheet and the process for producing the same of the presently disclosed subject matter will be described in detail.

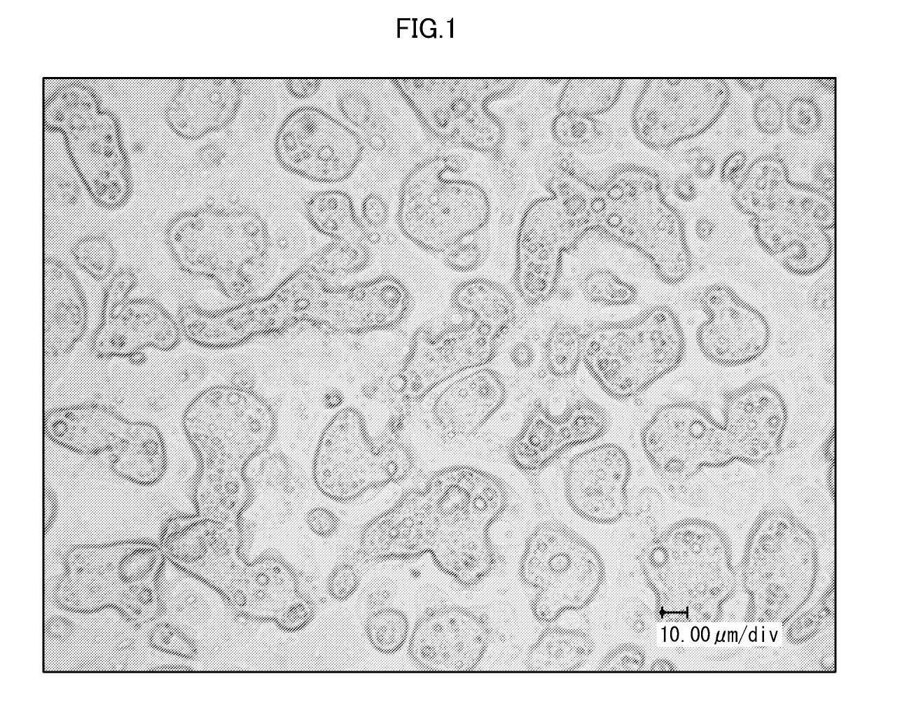

FIG. 1 is a reflection laser micrograph (magnification: 5 times) of a light scattering sheet of the presently disclosed subject matter.

As the micrograph of FIG. 1 illustrates, the phase separated concavity-and-convexity structure of the light scattering sheet is a sea-island structure of two or more resin materials, and domains constituting an island have a random shape mainly of a string shape. In other words, a random structure in which a plurality of string-shaped domains are intricately arranged is formed. This phase separated concavity-and-convexity structure offers good light scattering properties and has no large sea portion despite large concavity and convexity shapes on the sheet surface formed by phase separation, and thus is suitable for removing moire.

For the light scattering sheet of the presently disclosed subject matter having a phase separated concavity-and-convexity structure illustrated in FIG. 1, a coating layer formed by coating a transparent support with a coating solution prepared by dissolving a resin material containing of at least two kinds selected from polymers and monomers phase-separable with each other in a solvent is dried, thereby forming a light scattering layer with a phase separated concavity-and-convexity structure by spinodal decomposition. The light scattering layer can be produced by carrying out, upon drying, high speed drying at a drying speed of 3.0 g/m²·sec or more at a critical phase separation solid concentration of the coating layer. The drying speed at the critical phase separation solid concentration of the coating layer is more preferably 8 g/m²·sec or more and particularly preferably 10 g/m²·sec or more. The upper limit of the drying speed at the critical phase separation concentration is where no drying unevenness occurs, and for example, is preferably 20 g/m²·sec or less.

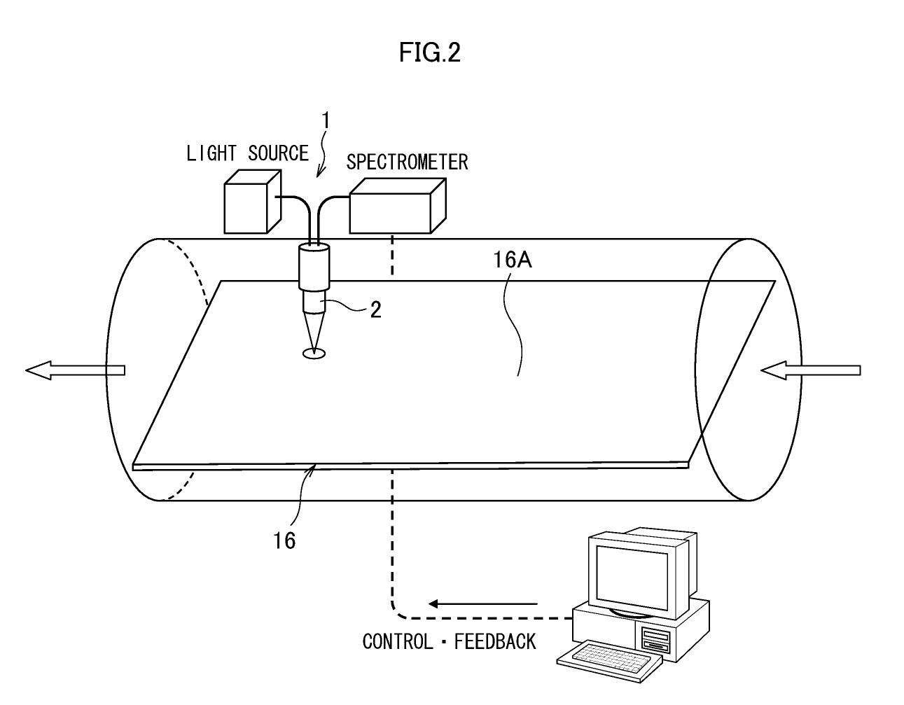

The drying speed for the coating layer can be measured, for example, by a portable FTIR (Fourier transform infrared spectroscopy) apparatus 1 illustrated in FIG. 2. As illustrated in FIG. 2, using the portable FTIR apparatus 1 with a sensor part 2 made of fiber, the change over time in the evaporation amount of a solvent in a coating layer upon drying can be examined based on the change in absorbance, from the top of the coating layer 16A on the transparent support 16 running in the direction of the arrow. VIR-9500 made by JASCO Corporation, for example, may be used as the FTIR apparatus 1.

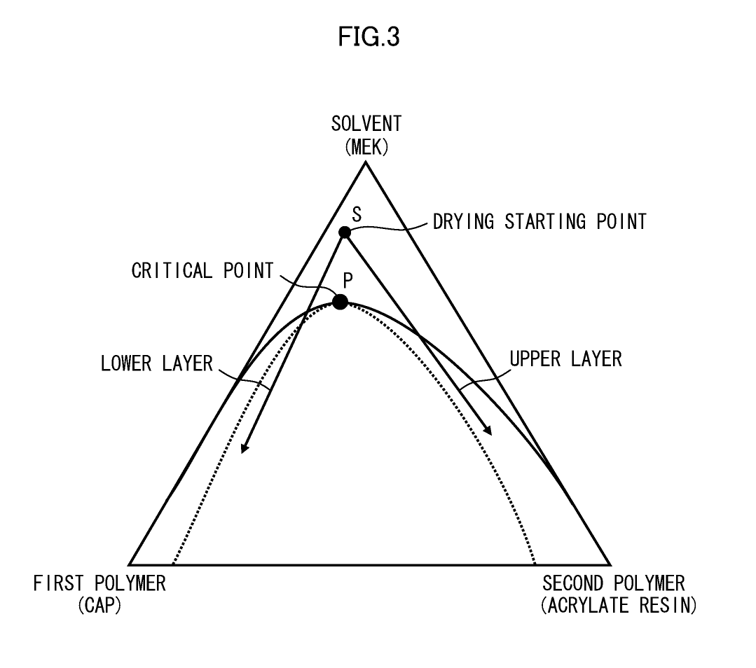

Also, the time for the solid concentration of the coating layer 16A to reach the critical phase separation solid concentration can be determined as follows. FIG. 3 is an exemplary triangular phase diagram illustrating phase separation of a solution containing first and second polymers incompatible and phase-separable with each other and a solvent in which the polymers are dissolved. The first polymer is cellulose acylate propionate (CAP), the second polymer is an acrylic resin, and the solvent is methyl ethyl ketone.

In FIG. 3, the solid curve represents a binodal curve which is the boundary where phase separation occurs. The dotted curve represents a spinodal curve. Phase separation occurs in a region inside of the binodal curve. The region surrounded by the binodal curve and the spinodal curve is called a metastable region, where phase separation develops by nuclear formation or a growth mechanism. The region inside of the spinodal curve is an unstable region, where phase separation is caused by spinodal decomposition. The point where the binodal curve and the spinodal curve meet is the critical point P where the phase separation by spinodal decomposition starts.

The critical point P can be determined from, for example, a literature (CORNELL UNIVERSITY PRESS, “Scaling Concepts in Polymer Physics”, pp. 94-96). Accordingly, the drying time for a coating layer to reach the critical concentration can be determined from the critical concentration, i.e., the solid concentration of the coating layer at the critical point P, and drying conditions (drying speed).

In the production of the light scattering sheet of the presently disclosed subject matter, it is important to rapidly increase the drying speed immediately after coating to prevent rotary convection from generating and developing in the coating layer and rapidly solidify the coating layer 16A once phase separation starts to suppress spread of domains formed by the phase separation. Much spread of domains leads to an excessive increase in transmitted image clarity, making it more likely to generate moire.

For this reason, a drying apparatus capable of drying the coating layer 16A immediately after coating and which is less likely to cause coating unevenness even if high speed drying is carried out immediately after coating is preferred. An integrated coating-drying apparatus with a structure of discharging a one-way flow of drying air W parallel to the surface of a support from the direction perpendicular to the running direction of the support may be preferably used as a drying apparatus satisfying the above conditions.

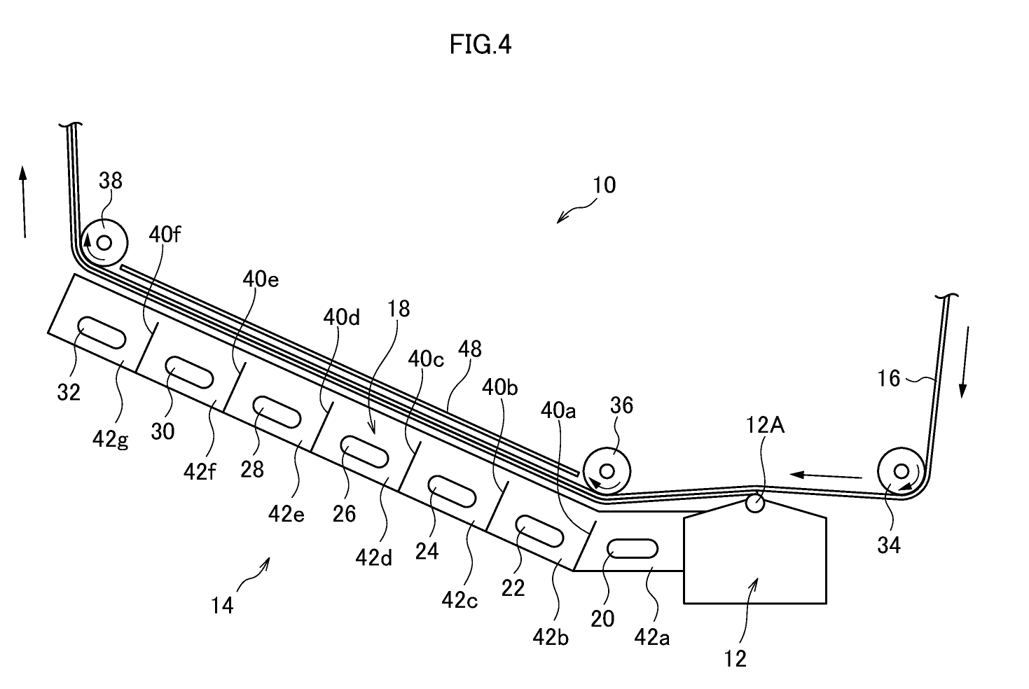

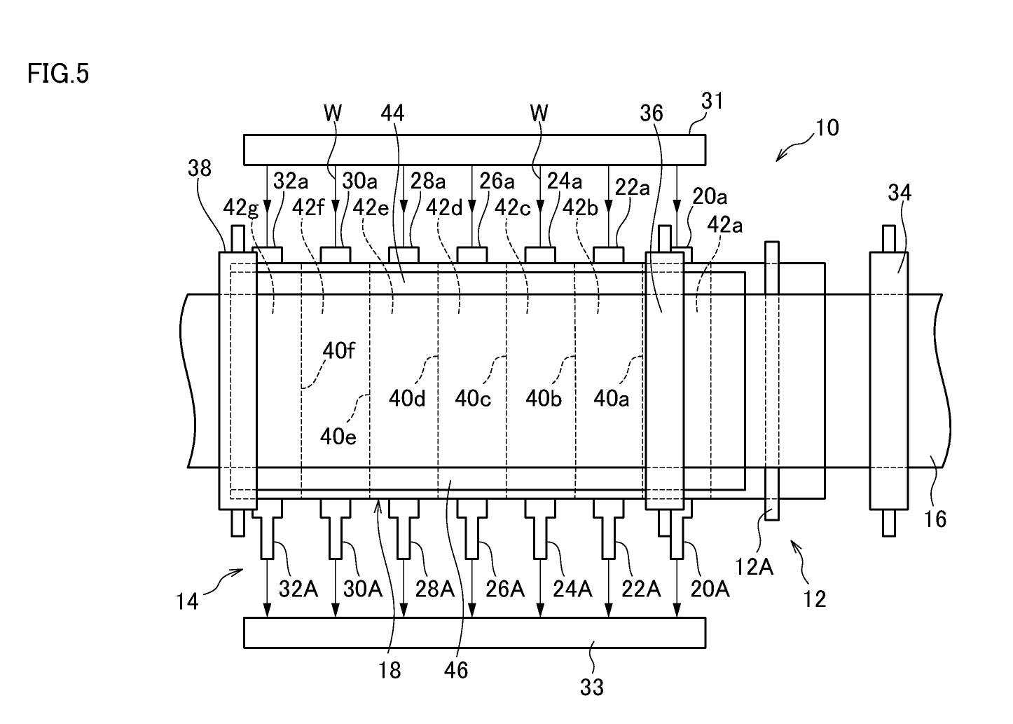

FIG. 4 is a side view of an example of the coating-drying apparatus 10 in which a coating unit 12 and a drying unit 14 are integrated. FIG. 5 is a top view of the coating-drying apparatus 10 of FIG. 4, which illustrates the coating-drying apparatus 10 from which a shielding plate (described later) has been removed.

As illustrated in FIG. 4 and FIG. 5, the coating-drying apparatus 10 includes a coating unit 12 configured to coat a continuously running belt-like transparent support 16 with a coating solution for light scattering sheet (hereinafter coating solution) to form a coating layer 16A on the transparent support 16; a drying unit 14 configured to dry the coating layer 16A by allowing the transparent support 16 to pass through a plurality of drying zones formed in a drying unit main body 18; and one-way airflow generating devices 20, 22, 24, 26, 28, 30 and 32 configured to generate a one-way flow of drying air W which flows from one end to the other end of the transparent support 16 in the width direction in each of the drying zones.

It is preferred that, in order to carry out high speed drying of the coating layer 16A applied in the coating unit 12 in the drying unit 14 immediately after coating, the distance between the coating unit 12 and the drying unit 14 and the running speed of the transparent support 16 be so set that the time from the completion of coating to the start of drying is 10 seconds or less, preferably 5 seconds or less, and particularly preferably 1 second or less.

A bar coating apparatus having a wire bar 12A, for example, may be used as the coating unit 12. A coating solution is applied to the underside of a transparent support 16 which runs with being held by a plurality of pass rollers 34, 36, 38 to form a coating layer 16A. Although FIG. 4 and FIG. 5 illustrate a wire bar coating unit as an example of the coating unit 12, the coating unit is not limited to such wire bar coating units.

Cellulose resins (e.g., triacetyl cellulose), polyester resins (e.g., polyethylene terephthalate), polysulfone resins (e.g., polysulfone), cyclic polyolefin resins (e.g., ARTON (a trade name of JSR Corporation's product which includes amorphous polyolefin)) and the like may be used as the transparent support 16. When the resulting light scattering sheet is also used as a protective sheet for a polarizing plate on the backlight side, triacetyl cellulose having low optical anisotropy such as retardation is preferably used as the transparent support 16.

Also, a solvent having a boiling point of 100° C. or lower which facilitate high speed drying is preferred as a solvent for the coating solution. For example, methanol, ethanol, acetone and methyl ethyl ketone (MEK) may be preferably used, and a mixture thereof may also be preferably used.

The drying unit main body 18 is located immediately behind the coating unit 12 and shaped like a long quadrangular box along the coating film side of the running transparent support 16 (underside of the transparent support 16). Of the sides of the box, the side facing the coating layer (the top side in FIG. 4) is removed. Thus, a drying zone with a U-shaped cross section which surrounds the coating layer 16A applied to the running transparent support 16 is formed. The drying unit main body 18 is partitioned by a plurality of partition boards 40a to 40f which are perpendicular to the running direction of the transparent support 16 to divide the drying zone into a plurality of drying zones 42a, 42b, 42c, 42d, 42e, 42f and 42g (7 separate zones are illustrated in this embodiment, but a number of the drying zones is not limited thereto). The distance between the upper end of the partition boards 40a to 40f separating the drying zones 42a to 42g and the surface of the coating layer is preferably 0.5 mm to 12 mm, more preferably 1 mm to 10 mm. The respective drying zones 42a to 42g have one-way airflow generating devices 20 to 32, respectively (see FIG. 5).

As illustrated in FIG. 5, the one-way airflow generating devices 20 to 32 includes suction ports 20a, 22a, 24a, 26a, 28a, 30a, 32a provided on one side of the both sides of the drying unit main body 18, exhaust ports 20A, 22A, 24A, 26A, 28A, 30A, 32A provided on the other side to be faced with the suction ports 20a to 32a, respectively; a drying air temperature control device 31 connected to each of the suction ports 20a to 32a; and an exhaust device 33 connected to each of the exhaust ports 20A to 32A.

The drying air temperature control device 31 is designed to be able to control the temperature of drying air supplied to the respective drying zones 42a to 42g per zone. Thus, by activating the exhaust device 33, the drying air W of a predetermined temperature sucked into each of the drying zones 42a to 42g from the suction ports 20a to 32a is discharged from the exhaust ports 20A to 32A. The drying air W which flows in one direction from one end (suction port side) to the other end (exhaust port side) in the width direction of the transparent support is generated in each of the drying zones 42a to 42g. The one-way airflow generating devices 20 to 32 are capable of controlling individually exhaust amounts (air speeds) by the exhaust device 33 per drying zone 42a to 42g, respectively.

Conditioned air at a conditioned temperature and humidity is preferred as the drying air W sucked through the suction ports 20a to 32a. Also, it is preferred that the drying air W sucked through the suction ports 20a to 32a be controlled so as to contain gas of the solvent for the coating solution at a predetermined concentration.

Further, it is preferred that the width of the drying unit main body 18 be greater than the width of the transparent support 16 and the open part on both sides of the drying zones 42a to 42g is covered with a lid plate 44, 46 to create an air stabilizing part. The air stabilizing part functions to keep a distance between the respective suction ports 20a to 32a and one end of the coating layer in the width direction, and to keep a distance between the other end of the coating layer in the width direction and the respective exhaust ports 20A to 32A. At the same time, the air stabilizing part facilitates suction of drying air W into the drying zones 42a to 42g through only the suction ports 20a to 32a. This avoids generation of airflow other than the drying air W flowing in one-way in the width direction of the transparent support in the drying zones 42a to 42g. The air stabilizing parts, in other words, the lid plates 44, 46, have a length of preferably 50 mm or more and 150 mm or less on both the suction port side and the exhaust port side.

It is preferred that, particularly for the drying zone 42a of the drying zones 42a to 42g, which is the closest to the coating unit 12, fresh air outside of the drying zone 42a, for example, conditioned air in the room where the coating-drying apparatus 10 is installed, be unlikely to enter the drying zone 42a immediately after the coating solution is applied to the transparent support 16. In the production of the light scattering sheet of the presently disclosed subject matter, it is important to carry out high speed drying, as soon as possible, immediately after coating so as to bring the solid concentration of the coating layer 16A to the critical concentration in short time. However, sudden contact of a coating layer with fresh air such as conditioned air immediately after coating is likely to cause drying unevenness. To avoid this, it is preferred that the first stage drying zone 42a be arranged to be adjacent to the coating unit 12. As an alternative measure, in addition to putting the lid plates 44, 46, it is preferable to adjust the position of the wire bar 12A of the coating unit 12 and the position of the pass roller 36 to allow the transparent support 16 to run very close to the drying zone 42a as if the transparent support 16 covers the open part of the drying zone 42a. Also, it is preferred that a shielding plate 48 (see FIG. 4) be installed on the opposite side of the drying unit main body 18 across the transparent support 16 so as to avoid disturbance of stable running of the transparent support 16 by airflow such as the aforementioned conditioned air.

The coating-drying apparatus 10 designed as described above is capable of carrying out drying immediately after coating, and since a one-way flow of drying air W is discharged parallel to the surface of a transparent support in the direction perpendicular to the running direction of the support, drying unevenness is unlikely to occur even at an increased air speed. This makes it possible to carry out high speed drying “at a drying speed of 3.0 g/m²·sec or more at a critical phase separation solid concentration in a coating layer”, which is the drying condition for producing the light scattering sheet of the presently disclosed subject matter.

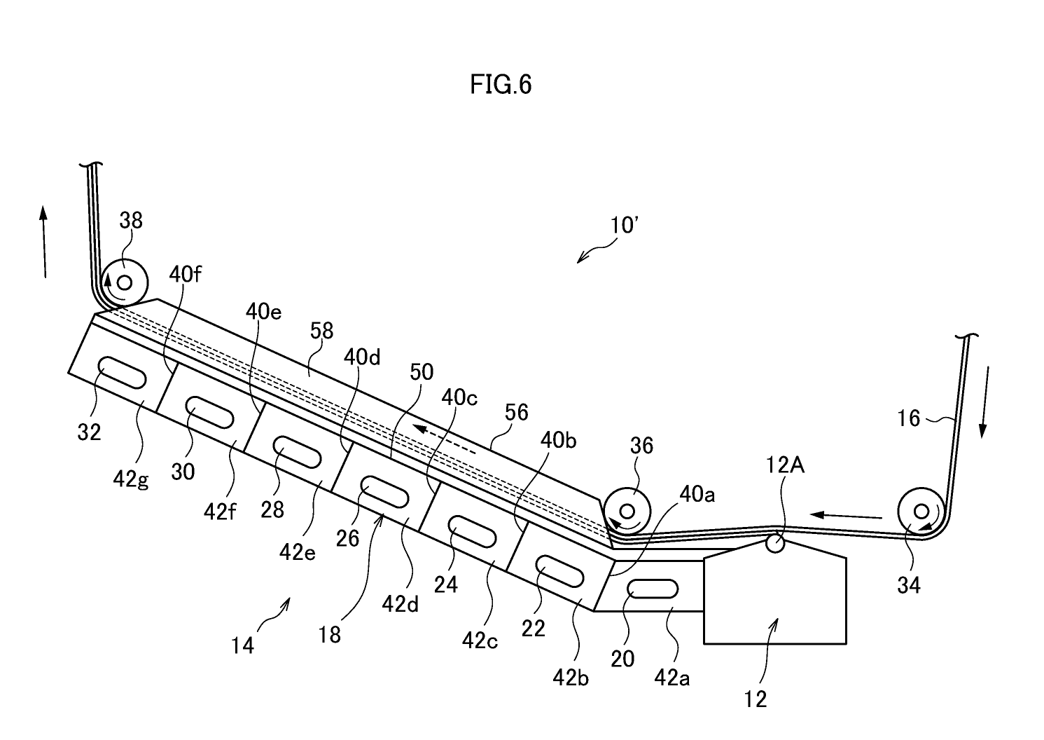

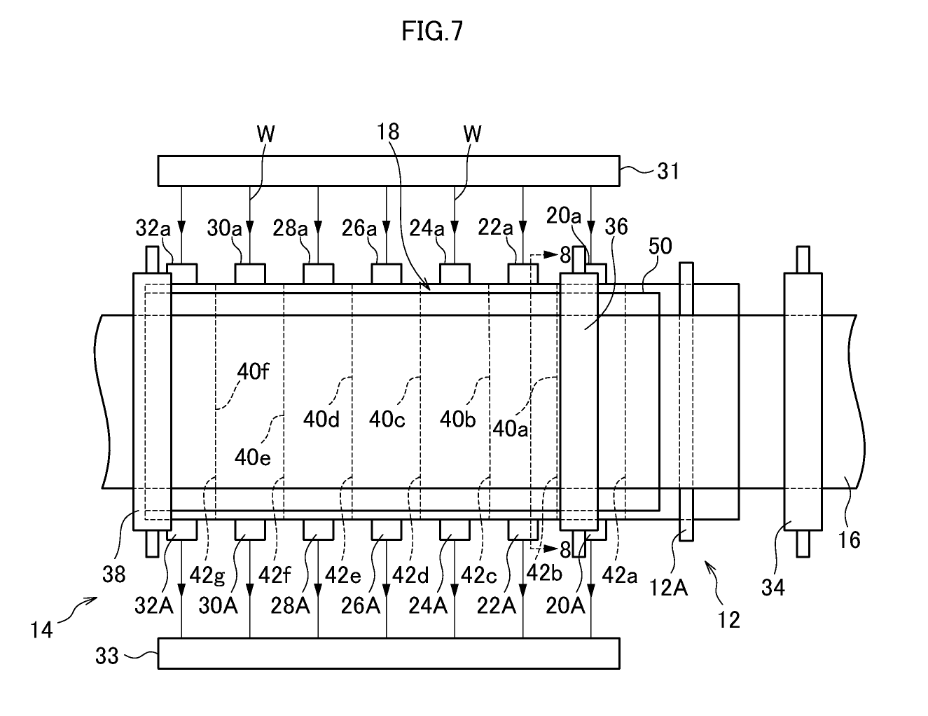

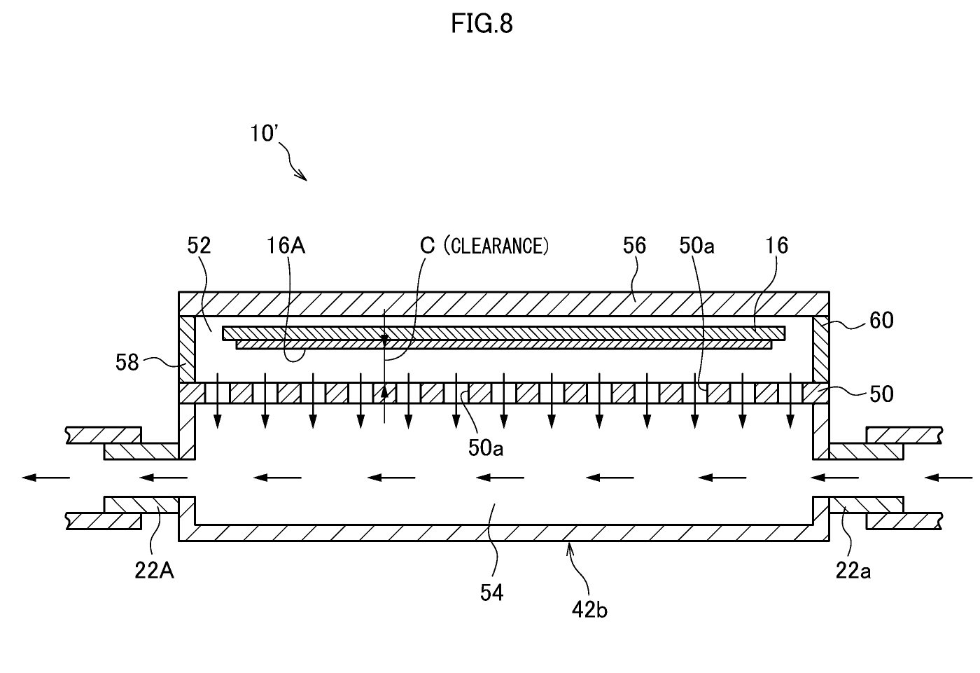

FIG. 6 is a side view illustrating a modified example 10′ of the coating-drying apparatus 10 illustrated in FIG. 4 and FIG. 5. FIG. 7 is a top view of the coating-drying apparatus 10′ of FIG. 6. FIG. 8 is a cross-sectional view of the main part of the drying unit main body 18 which is the feature of the modified example illustrated in FIG. 6 (8-8 cross-sectional view of FIG. 7). FIG. 7 illustrates the apparatus from which the upper lid described later has been removed.

The drying unit 14 of the coating-drying apparatus 10 illustrated in FIG. 4 and FIG. 5 has a structure in which drying air W flows in one-way from the suction ports to the exhaust ports 20A to 32A in contact with the surface of the coating layer applied to the transparent support 16. On the other hand, the coating-drying apparatus 10′ of a modified example described below has a structure in which the drying air W flowing in one-way is not in direct contact with the surface of the coating layer.

No description is made on FIG. 6 and FIG. 7 since they are substantially the same as FIG. 4 and FIG. 5 described above, and the same members are described with the same reference numerals.

FIG. 8 illustrates a cross-sectional view of the second stage drying zone 42b of the divided seven drying zones 42a to 42g in a direction perpendicular to the running direction of the transparent support 16. The other drying zones have the same or similar structure.

In the drying zone 42b, an air stabilizing board 50 which has a plane parallel to the transparent support 16 and has many holes (pores) 50a is provided. Although aperture ratios and materials of the air stabilizing board 50 are not particularly limited, wire gauze (metallic mesh) or perforated metal having an aperture ratio of 50% or less, is preferred. The aperture ratio is more preferably 20% to 40%. Specifically, wire gauze of 300 mesh having an aperture ratio of 30% may be used.

The air stabilizing board 50 separates the drying zone 42b into a channel chamber 52 through which the transparent support 16 passes and an exhaust chamber 54 for discharging a solvent evaporated from the coating layer 16A by the drying air W flowing in one-way in the width direction of the transparent support 16. The exhaust chamber 54 has the suction port 22a and the exhaust port 22A, and the exhaust port 22A is connected to the exhaust device 33.

When the clearance between the coating layer 16A applied to the transparent support 16 and the air stabilizing board 50 is large, the drying air W generates vortexes, causing drying unevenness on the surface of the coating layer 16A. Therefore, to control the flow of the drying air W, the clearance C between the coating layer 16A and the air stabilizing board 50 is preferably 3 mm to 30 mm, more preferably 5 mm to 15 mm. Also, to suppress unnecessary airflow from the back side (side on which no coating film is formed) and the lateral sides of the transparent support 16, sealing members, i.e., an upper lid 56 and side seals 58, 60 are attached.

With the structure of the drying unit 14 of the coating-drying apparatus 10′ of a modified example described above, the solvent gas evaporated from the coating layer 16A passes through pores 50a of the air stabilizing board 50 with being pulled by the drying air W flowing in one-way in the width direction of the transparent support 16, enters the exhaust chamber 54 and is discharged to the outside of the drying zone 42b from the exhaust port 22A.

Thus, since the drying air W does not come in direct contact with the surface of the coating layer 16A, drying unevenness is less likely to occur on the surface of the coating layer even if the speed of the drying air W flowing in one-way from the suction port to the exhaust port is higher than that of the drying unit illustrated in FIG. 2 and FIG. 3.

This makes it possible to dry the coating layer applied to the transparent support 16 immediately after coating by high speed drying at a drying speed of 3.0 g/m²·sec or more at a critical phase separation solid concentration of the coating layer. As a result, the solid concentration in the coating layer rapidly increases, making it possible to dry the coating layer under drying conditions where rotary convection hardly occurs. The conditions specifically include a Marangoni number of less than 80 at the critical concentration.

Consequently, domains formed by phase separation are random, string-shaped domains as illustrated in FIG. 1, not regular vortical domains formed by rotary convection, and a phase separated concavity-and-convexity structure with concavity-and-convexity distribution of domains is formed.

The upper limit of the drying speed at the critical phase separation solid concentration is where no drying unevenness occurs, and for example, is preferably 20 g/m²·sec or less.

The use of the coating-drying apparatus described above makes it possible to control the speed of the drying air W in each of the drying zones partitioned by a partition board. Therefore, the drying speed in the presently disclosed subject matter can be satisfied by controlling the speed of the drying air W with setting the temperature of the drying air W at the boiling point of the solvent for the coating solution or higher and 130° C. or lower. As a result, even if high speed drying is carried out using a transparent support made of triacetyl cellulose, drying can be done without generating wrinkles on the transparent support.

After coating and drying, the coating layer is transferred to a curing step and cured.

For the curing method for curing the coating layer of the light scattering sheet in the presently disclosed subject matter, it is preferred that the coating layer containing an ionizing radiation-curable compound be cured by a cross-linking reaction or a polymerization reaction by irradiating the coating layer with light or electron beams, or by heating. It is preferred that the coating layer be cured in an atmosphere having an oxygen concentration of 10% by volume or less. By curing in an atmosphere having an oxygen concentration of 10% by volume or less, an outermost layer having excellent physical strength and chemical resistance (chemical proof) can be obtained. The oxygen concentration is preferably 5% by volume or less, more preferably 1% by volume or less, particularly preferably 0.5% by volume or less, and most preferably 0.1% by volume or less.

A preferred method for setting the oxygen concentration at 10% by volume or less is to substitute atmosphere (nitrogen concentration: about 79% by volume, oxygen concentration: about 21% by volume) with another gas. Substituting with nitrogen (nitrogen purging) is particularly preferred.

The light source for the light irradiation may be any one as long as it is in the ultraviolet region or the near infrared region. Examples of ultraviolet light sources include ultrahigh pressure, high pressure, middle pressure or low pressure mercury lamps, chemical lamps (chemical light sources), carbon arc lamps, metal halide lamps, xenon lamps and sunlight. Various available laser light sources having a wavelength of 350 to 420 nm may be converted into multiple beams to be used for irradiation.

Examples of near infrared light sources include halogen lamps, xenon lamps and high pressure sodium lamps. Various available laser light sources having a wavelength of 750 to 1400 nm may be converted into multiple beams to be used for irradiation.

When a near infrared light source is used, the light source may be used in combination with an ultraviolet light source, or the light may be applied from the substrate side, which is the opposite side of the coating surface. Thus, curing of the film in the depth direction of the coating layer develops as promptly as it does in the vicinity of the surface, resulting in a uniformly cured film.

The irradiation intensity of the ultraviolet light applied is preferably about 0.1 to 1000 mW/cm², and the irradiation amount thereof on the surface of the coating layer is preferably 10 to 1000 mJ/cm². During irradiation, higher uniformity of the temperature distribution of the coating layer is preferred. The temperature distribution is controlled to preferably within ±3° C., more preferably within ±1.5° C. This range of the temperature distribution is preferred since a polymerization reaction develops uniformly on the plane and in the depth direction of the coating layer.

Through the coating step, the drying step and the curing step described above, a light scattering sheet which has excellent light scattering properties and can effectively prevent uneven brightness or moire from occurring can be produced, and since the light scattering sheet can also serve as a protective sheet for a polarizing plate as triacetyl cellulose is used as a support, the number of members can be reduced and thinning of liquid crystal display devices can be accomplished.

The light scattering sheet of the presently disclosed subject matter obtained through the above coating step, drying step and curing step has the following optical properties. Specifically, the light scattering sheet has a total light transmittance of 95% or more, a scattered light intensity)(0°/30° of 0.001 to 0.10, a transmitted image clarity of 10 to 30% and a haze of 20 to 60%. Also, a percentage of a surface inclination angle in the range of 2.5° to 7.5° is 21% to 50% the phase separated concavity-and-convexity structure formed on the light scattering sheet. The light scattering sheet has a surface roughness Ra of 0.3 μm or more and an area ratio of string-shaped domains in the convex part of 50% or less.

### Examples

Hereinafter the features of the presently disclosed subject matter will be described in more detail with reference to Examples, but the scope of the presently disclosed subject matter should not be construed as limited to the specific examples below.

### [Composition of Coating Solution for Light Scattering Layer]

| | |
|---|---|
| Acrylic resin | 65.0 g |
| Cellulose acetate propionate | 3.0 g |
| Dipentaerythritol hexaacrylate | 15.0 g |
| IRGACURE 184 | 0.2 g |
| (IRGACURE is a registered trade | |
| mark of Japan, and IRGACURE 184 | |
| includes 1-hydroxy cyclohexyl phenylketone) | |
| Methyl ethyl ketone (MEK) | 32.5 g |

### [Testing Method]

Triacetyl cellulose having a width of 1,000 mm (FUJITAC available from FUJIFILM Corporation) was used as a transparent support. The coating solution for a light scattering layer of the above composition was continuously applied onto the running transparent support 16 by the bar coating unit 12 of the coating-drying apparatus 10 illustrated in FIG. 4 and FIG. 5. The coating layer 16A was dried by a drying unit immediately after coating.

In the drying, the temperature of the drying air was controlled by the drying air temperature control device 31, and the speed (amount) of the drying air flowing in one-way through the drying zones 42a to 42g was adjusted by the exhaust device 33. By doing so, the drying speed at the critical phase separation solid concentration of the coating layer was controlled to be those in the following Tests 1 to 9.

Further, the influence of the change in the thickness of the transparent support and the film thickness (film thickness after drying) of the coating layer in addition to the influence of the change in the drying speed at the critical phase separation solid concentration was examined.

### (Test 1)

The drying speed at the critical phase separation solid concentration was 11.0 g/m²·s. In Test 1, the transparent support had a thickness of 80 μm, and the coating layer had a film thickness of 8 μm.

### (Test 2)

Test 2 was carried out in the same manner as in Test 1, except that the thickness of the transparent support was changed to 40 μm from 80 μm in Test 1. Accordingly, the drying speed at the critical phase separation solid concentration was 11.0 g/m²·s.

### (Test 3)

Test 3 was carried out in the same manner as in Test 1, except that the film thickness of the coating layer was changed to 12 μm from 8 μm in Test 1. Accordingly, the drying speed at the critical phase separation solid concentration was 11.0 g/m²·s.

### (Test 4)

Test 4 was carried out in the same manner as in Test 1, except that the film thickness of the coating layer was changed to 15 μm from 8 μm in Test 1. Accordingly, the drying speed at the critical phase separation solid concentration was 11.0 g/m²·s.

### (Test 5)

Test 5 was carried out in the same manner as in Test 2, except that the film thickness of the coating layer was changed to 15 μm from 8 μm in Test 2. Accordingly, the drying speed at the critical phase separation solid concentration was 11.0 g/m²·s.

### (Test 6)

Test 6 was carried out in the same manner as in Test 4, except that the drying speed at the critical phase separation solid concentration was changed to 8.0 g/m²·s from 11.0 g/m²·s in Test 4.

### (Test 7)

Test 7 was carried out in the same manner as in Test 1, except that the drying speed at the critical phase separation solid concentration was changed to 3.0 g/m²·s from 11.0 g/m²·s in Test 1.

### (Test 8)

Test 8 was carried out in the same manner as in Test 1, except that the drying speed at the critical phase separation solid concentration was changed to 0.5 g/m²·s from 11.0 g/m²·s in Test 1.

### (Test 9)

Test 9 was carried out in the same manner as in Test 1, except that the drying speed at the critical phase separation solid concentration was changed to 0.2 g/m²·s from 11.0 g/m²·s in Test 1.

### (Test 10)

Test 10 was carried out in the same manner as in Test 4, except that the drying speed at the critical phase separation solid concentration was changed to 0.7 g/m²·s from 11.0 g/m²·s in Test 4.

Polarizing plates were prepared as follows using the light scattering sheets prepared in above Tests 1 to 10.

### (Preparation of Polarizing Plate)

Iodine was adsorbed to polyvinyl alcohol and the resultant was stretched to prepare a polarizing film. The respective light scattering sheets of Tests 1 to 10 were attached to the backlight side of the polarizing film, and a triacetyl cellulose film having a thickness of 80 μm (FUJITAC available from FUJIFILM Corporation) was attached to the opposite side of the polarizing film. A film prepared by immersing in a 1.5 mol/L NaOH aqueous solution (water solution) at 55° C. for 2 minutes and then neutralizing and washing with water was used as the triacetyl cellulose film. Polarizing plates were prepared in the above manner.

Further, the light scattering sheets and the polarizing plates prepared as described above were evaluated as follows.

### [Method of Evaluation of Light Scattering Sheet and Polarizing Plate]

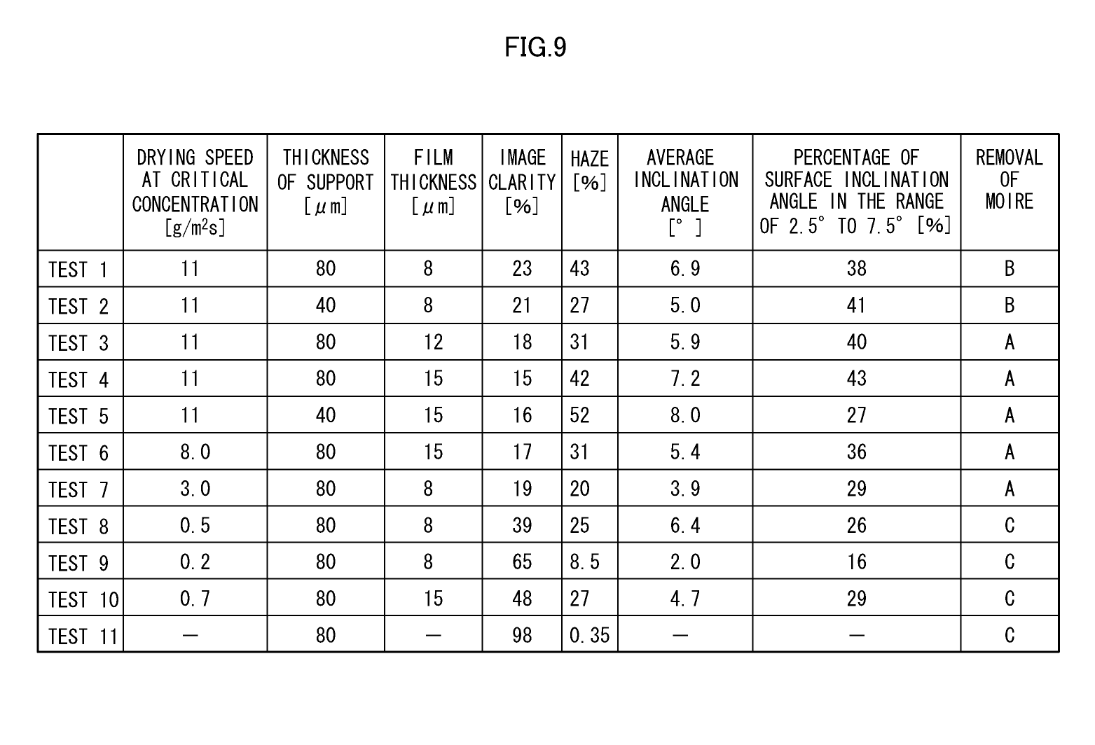

The light scattering sheets prepared in the above Tests 1 to 10 were evaluated with the following items. The results are illustrated in the table of FIG. 9.

### (1) Transmitted Image Clarity (Image Clarity)

The image clarity (%) of the light scattering sheets was measured in accordance with JIS K7105 (1999), which is one of the Japanese Industrial Standards concerning testing method for testing optical property of plastic by an image clarity measuring instrument ICM-1T made by Suga Test Instruments Co., Ltd. Values measured using an optical comb of 2.0 mm-width were determined to be the image clarity in the presently disclosed subject matter. The image clarity preferably ranges from 10% to 30%.

### (2) Haze

The total haze value (H) of the resulting light scattering sheets was measured in accordance with JIS-K7136 (one of the Japanese Industrial Standards concerning testing method for determination of haze for plastic-transparent materials). The haze value preferably ranges from 20% to 60%.

### (3) Inclination Angle Distribution Profile (Percentage of Surface Inclination Angle in the Range of 2.5° to 7.5°)

The light scattering sheets prepared were subjected to measurement using a slope measurement Model SXM520-AS150 made by Micromap Corporation (USA). A halogen lamp with an interference filter having a central wavelength of 560 nm inserted thereinto was used as a light source. The objective lens has a magnification of ×10. Data was read using a ⅔ inch CCD (charge-coupled device) having a number of pixels of 640×480. The measurement pitch in the longitudinal direction and the transverse direction was 1.3 micrometers, the measurement unit of the inclination angle was 0.8 square micrometers, and the measurement area was 500,000 square micrometers (0.5 square millimeters). The inclination angle was calculated from the data of heights of 3 points. The average inclination angle and the percentage of a surface inclination angle in the range of 2.5° or more and 7.5° or less were determined from all measured data. The phase separated concavity-and-convexity structure has a percentage of a surface inclination angle in the range of 2.5° to 7.5° of preferably 21% to 50%.

### (4) Light Scattering Profile

The light scattering profile was measured using a goniophotometer (GP-5 made by MURAKAMI COLOR RESEARCH LABORATORY Co., Ltd.). For the measurement conditions, the light source was converging light with an angle of 1.5° and the acceptance angle of the detector was 2°. Light was allowed to enter the resulting light scattering sheets from the normal direction of the sheets, and the amount of transmitted and scattered light was measured with continuously changing angles in the plane including the normal line of the sheet to obtain a light scattering profile. For the amount of transmitted and scattered light, the amount of light of the light source without the sheet was determined to be 1.

### (5) Evaluation of Removal of Moire

For the evaluation of the “removal of moire”, a notebook-size personal computer was remodeled as follows.

### <Remodeling of Notebook-Size Personal Computer>

A notebook-size personal computer made by LG Display Co., Ltd. (R700-XP50K) was disassembled and the upper diffusion sheet between the backlight and the liquid crystal panel was removed. Further, the polarizing plate on the backlight side, which was attached to the liquid crystal cell was stripped off and the light scattering sheet prepared as described above was attached thereto with an adhesive material. One prepared by attaching a polarizing plate without a light scattering sheet (in which FUJITAC was used as a protective film on both sides of a polarizing film) was used in Test 11.

Signals were inputted to the respective resulting liquid crystal display devices by Video Signal Generator (VG-848 made by ASTRO DESIGN Inc.), and on a full solid, 128/256-gradation gray display mode, the screen was visually observed from various direction in a darkroom. Whether moire was generated or not was evaluated according to the following moire evaluation criteria.

### <Evaluation Criteria of Removal of Moire>

A: No moire observed.
B: Weak moire observed.
C: Clear moire observed.

### [Test Results]

As illustrated in a table in FIG. 9, in Tests 1 to 7 in which the solid concentration in a coating layer applied to a transparent support was brought to the critical phase separation concentration and high speed drying was carried out at a drying speed at the critical phase separation solid concentration of 3.0 g/m²·sec or more in the drying step of the coating layer, moire could be effectively prevented with maintaining excellent light scattering properties. Also, the above-described preferred conditions in the presently disclosed subject matter have been met for all items of the “image clarity”, the “haze” and the “percentage of a surface inclination angle in the range of 2.5° to 7.5°” in Tests 1 to 7.

On the other hand, in Tests 8, 9, 10 in which the drying speed at the critical phase separation solid concentration is lower than 3.0 g/m²·sec, clear moire was observed. Moreover, the image clarity was 39 to 65% in Tests 8, 9, 10, failing to meet the preferred condition.

In the presently disclosed subject matter, MEK having a boiling point of 100° C. or less was used as a solvent for the coating solution, and the temperature of the drying air was kept at the boiling point of the solvent or higher and 130° C. or lower and the speed of the drying air was increased to achieve a drying speed of 3.0 g/m²·sec or more in the high speed drying in the drying step. As a result, a light scattering sheet could be produced without wrinkles even if triacetyl cellulose was used as a transparent support. Thus, the light scattering sheet can also serve as a protective sheet for a polarizing plate, and therefore the number of members has been reduced and thinning of liquid crystal display devices has been accomplished.

Further, the influence of the change in the thickness of the transparent support and the film thickness of the coating layer was examined in Tests 1 to 7, and good results were obtained without the influence of the thickness of the transparent support or the film thickness of the coating layer by carrying out high speed drying at a drying speed of 3.0 g/m²·sec or more at a critical phase separation concentration of the coating layer applied to the transparent support.

Test 11 showed the worst result of an image clarity of 98%, a haze of 0.35% and clear moire.

What is claimed is:

1. A process for producing a light scattering sheet comprising:
a coating step of coating a transparent support with a coating solution prepared by dissolving a resin material including at least two kinds selected from polymers and monomers phase-separable with each other in a solvent to form a coating layer; and
a drying step of drying the coating layer to form a phase separated concavity and convexity structure on the coating layer by spinodal decomposition,
wherein, in the drying step, high speed drying is carried out at a drying speed of 3.0 g/m²·sec or more at a critical phase separation concentration of the coating layer applied to the transparent support.

2. The process for producing a light scattering sheet according to claim 1,
wherein a Marangoni number is less than 80 at the critical phase separation concentration in the drying step.

3. The process for producing a light scattering sheet according to claim 1,
wherein, in the coating step, the solvent for the coating solution includes a solvent having a boiling point of 100° C. or less, and
in the high speed drying in the drying step, a temperature of drying air is kept at the boiling point of the solvent or higher and 130° C. or lower, and the drying speed is achieved by increasing a speed of the drying air.

4. The process for producing a light scattering sheet according to claim 1,
wherein the coating solution includes an ionizing radiation-curable compound, and
the coating layer applied to the transparent support is cured by a cross-linking reaction or a polymerization reaction by irradiating the coating layer with light or electron beams or by heating, thereby fixing the phase separated concavity and convexity structure formed.

5. The process for producing a light scattering sheet according to claim 1,
wherein the monomers include a multifunctional monomer.

6. The process for producing a light scattering sheet according to claim 1,
wherein a surfactant is included as one of the polymers or monomers.

7. A light scattering sheet comprising:
a transparent support; and
a light scattering layer formed on a transparent support, the light scattering layer having a phase separated concavity and convexity structure formed by phase separation of two or more resin materials phase-separable with each other,
wherein the phase separated concavity and convexity structure is a sea-island structure of the two or more resin materials, and
a plurality of domains constituting an island have a random shape mainly having a string shape.

8. The light scattering sheet according to claim 7,
wherein the sheet has a transmitted image clarity of 10% to 30% and a haze of 20% to 60%, and
a percentage of a surface inclination angle of the phase separated concavity and convexity structure in the range of 2.5° to 7.5° of 21% to 50%.

9. The light scattering sheet according to claim 7,
wherein triacetyl cellulose is used as the transparent support, and
the light scattering sheet also serves as a protective sheet for a polarizing plate on the backlight side of a liquid crystal display device.

10. The light scattering sheet according to claim 7,
wherein the two or more resin materials have a different refractive indices.

11. The light scattering sheet according to claim 7,
wherein, at least one of the two or more resin materials is a (meta-)acrylate resin.
